(19) United States
(12) Patent Application Publication
(10) Pub. No.: US 2025/0238996 A1
(43) Pub. Date: Jul. 24, 2025

(54) RAY TRACING FOR RENDERING MESHES PRODUCED BY MACHINE LEARNING TECHNIQUES

(71) Applicant: QUALCOMM Incorporated, San Diego, CA (US)

(72) Inventors: Alexei Vladimirovich BOURD, San Diego, CA (US); Aleksandra HANNAN, La Jolla, CA (US); Zifeng LI, San Diego, CA (US)

(21) Appl. No.: 18/420,268

(22) Filed: Jan. 23, 2024

(51) Int. Cl. G06T 15/00; G06T 15/06; G06T 15/10

(52) U.S. Cl. CPC G06T 15/005; G06T 15/06; G06T 15/10; G06T 2210/21

(57) ABSTRACT

Aspects of the disclosure are directed to three-dimensional (3D) computer graphics processing. In accordance with one aspect, the disclosure includes a memory configured to store a learned triangle mesh and a learned feature texture; a graphics processing unit (GPU) coupled to the memory, the GPU configured to render an inferred three-dimensional (3D) scene based on the learned triangle mesh and the learned feature texture using a ray tracing; and a display unit coupled to the GPU, the display unit configured to display the inferred 3D scene.

### TECHNICAL FIELD

This disclosure relates generally to the field of information processing, and, in particular, to three-dimensional (3D) computer graphics processing using machine learning (ML).

### BACKGROUND

In three-dimensional (3D) computer graphics, one requirement is synthesis of a 3D scene from a plurality of two-dimensional (2D) images. A number of graphics processing techniques have emerged for rendering graphical meshes as part of the 3D scene synthesis. Many of these graphics processing techniques are computationally demanding so that there is high interest in more efficient 3D computer graphics processing which use machine learning (ML).

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides three-dimensional (3D) computer graphics processing. Accordingly, the disclosure provides an apparatus including: a memory configured to store a learned triangle mesh and a learned feature texture; a graphics processing unit (GPU) coupled to the memory, the GPU configured to render an inferred three-dimensional (3D) scene based on the learned triangle mesh and the learned feature texture using a ray tracing; and a display unit coupled to the GPU, the display unit configured to display the inferred 3D scene.

In one example, the GPU comprises a shader processor configured to process the learned triangle mesh and the learned feature texture. In one example, the GPU further comprises a ray traversal unit configured to perform the ray tracing. In one example, the ray tracing includes a determination of primary visibility. In one example, the ray tracing includes a bounding volume hierarchy (BVH) technique.

In one example, the shader processor is further configured to infer the inferred three-dimensional (3D) scene to output view-dependent colors. In one example, the shader processor is further configured to synthesize the inferred three-dimensional (3D) scene using the reduced neural network with the ray tracing. In one example, the shader processor is further configured to backpropagate a plurality of two-dimensional (2D) images to the reduced neural network, an initial feature field neural network and an initial opacity field neural network to generate an updated learned triangle mesh and an updated learned feature texture and an updated reduced neural network. In one example, the shader processor is further configured to infer the updated reduced neural network using a forward propagation and with the ray tracing. In one example, the shader processor is further configured to synthesize the inferred three-dimensional (3D) scene using the updated reduced neural network with the updated learned triangle mesh and the updated learned feature texture and with the ray tracing.

Another aspect of the disclosure provides a method including: using an initial mesh and an initial feature texture generated by an initial feature field neural network and an initial opacity field neural network with a plurality of two-dimensional (2D) images; and synthesizing an initial three-dimensional (3D) scene using an initial reduced neural network, the initial mesh and the initial feature texture with a ray tracing.

In one example, the initial reduced neural network is a multilayer perceptron (MLP) neural network. In one example, the initial mesh is a set of three-dimensional (3D) spatial samples which represents a geometric object. In one example, the ray tracing includes a determination of primary visibility. In one example, the ray tracing includes a bounding volume hierarchy (BVH) technique.

In one example, the method further includes using a forward propagation for synthesizing the initial three-dimensional (3D) scene. In one example, the method further includes backpropagating the initial 3D scene to the initial reduced neural network, the initial feature field neural network and the initial opacity field neural network to create a trained reduced neural network using a forward propagation and with the ray tracing.

In one example, the method further includes synthesizing an inferred three-dimensional (3D) scene using an updated reduced neural network with an updated learned mesh and an updated learned feature texture and with the ray tracing. In one example, the ray tracing includes a determination of primary visibility. In one example, the ray tracing includes a bounding volume hierarchy (BVH) technique.

In one example, the method further includes outputting one or more view-dependent 3D scenes from an updated mesh and an updated feature texture. In one example, the initial reduced neural network has a lower dimensionality than the initial feature field neural network and the initial opacity field neural network.

In one example, the method further includes establishing the initial feature field neural network and the initial opacity field neural network. In one example, the method further includes ingesting the plurality of two-dimensional (2D) images for machine learning (ML) training.

Another aspect of the disclosure provides an apparatus including: means for using an initial mesh and an initial feature texture generated by an initial feature field neural network and an initial opacity field neural network with a plurality of two-dimensional (2D) images; and mean for synthesizing an initial three-dimensional (3D) scene using an initial reduced neural network, the initial mesh and the initial feature texture with a ray tracing.

In one example, the apparatus further includes: means for backpropagating the initial 3D scene to the initial reduced neural network, the initial feature field neural network and the initial opacity field neural network to create a trained reduced neural network using a forward propagation and with the ray tracing; and means for synthesizing an inferred three-dimensional (3D) scene using an updated reduced neural network with an updated learned mesh and an updated learned feature texture and with the ray tracing.

In one example, the apparatus further includes: means for establishing the initial feature field neural network and the initial opacity field neural network; and means for ingesting the plurality of two-dimensional (2D) images for machine learning (ML) training.

Another aspect of the disclosure provides a non-transitory computer-readable medium storing computer executable code, operable on a device including at least one processor and at least one memory coupled to the at least one processor, wherein the at least one processor is configured to implement a three-dimensional (3D) scene synthesis using a ray tracing, the computer executable code including: instructions for causing a computer to use an initial mesh and an initial feature texture generated by an initial feature field neural network and an initial opacity field neural network with a plurality of two-dimensional (2D) images; and instructions for causing the computer to synthesize an initial three-dimensional (3D) scene using an initial reduced neural network, the initial mesh and the initial feature texture with the ray tracing.

In one example, the non-transitory computer-readable medium further includes: instructions for causing the computer to backpropagate the initial 3D scene to the initial reduced neural network, the initial feature field neural network and the initial opacity field neural network to create a trained reduced neural network using a forward propagation and with the ray tracing; and instructions for causing the computer to synthesize an inferred three-dimensional (3D) scene using an updated reduced neural network with an updated learned mesh and an updated learned feature texture and with the ray tracing.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example overview of a NeRF technique.

FIG. 3 illustrates a volume density example.

FIG. 4 illustrates a volume rendering example.

FIG. 5 illustrates a multilayer perceptron (MLP) training example.

FIG. 6 illustrates an example machine learning (ML) inference algorithmic flow.

FIG. 7 illustrates an example overview of ray tracing.

FIG. 8 illustrates an example apparatus for three-dimensional (3D) scene synthesis.

FIG. 9 illustrates an example flow diagram for three-dimensional (3D) scene synthesis using ray tracing and machine learning (ML).

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), may be used to synthesize a 3D scene using a plurality of 2D images. Synthesis, or rendering, of a 3D scene may be performed using a plurality of 2D images as a basis for the 3D scene rendering. In one example, 3D scene rendering may be computationally demanding such that execution on a given computing platform may not be performed in real time. That is, the computational processing rate for 3D scene rendering may exceed the capabilities of the given computing platform to complete the execution in desired timeline (e.g., at a real time display rate).

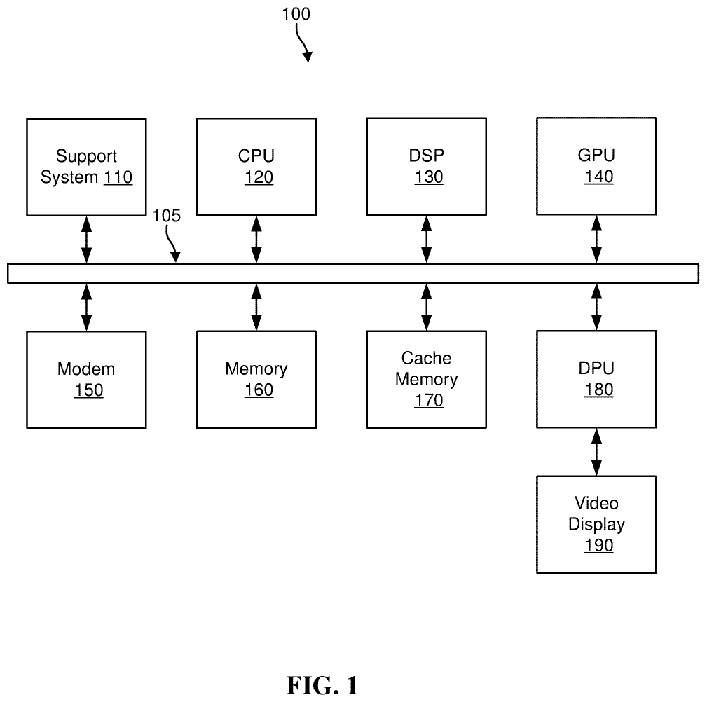

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory which is not shared with the other processing engines.

In one example, 3D graphics asset generation for 3D scene synthesis, for example, generation of meshes of triangles or textures, has evolved from simple rough sketches to full movie-realistic representations of natural and man-made objects. In one example, mesh and texture creation tools have been developed to run on a graphics processing unit (GPU). For example, most GPUs have post-vertex transformation cache memories which are optimized for meshes which represent connected tessellations (e.g., tilings) which exhibit appropriate locality similar to space-filling curves. In another example, a co-optimization technique may be used to set an average triangle size in pixels (e.g., in the range 30-100) depending on GPU tier. In one example, a typical GPU has an appropriately sized ratio of pixel fill throughput to triangle processing throughput. For example, GPU processing of triangle meshes without closely spaced repeating vertices or having very small triangles may result in significant performance degradation since the GPU may be optimized for common offline mesh optimization tools.

In one example, an issue with fixed function triangle processing is a hard upper limit on number of triangles per unit time. For example, the number of triangles per unit time may not be scaled up easily (unlike the quantity of ALUs in a GPU) such that content creators may need to optimize mesh size to fit this hard upper limit to achieve high quality until a real time performance constraint (e.g., 30 to 90 frames per second) is reached.

In one example, various synthesis techniques allow rendering of more triangles per unit time than the GPU fixed function hardware design capability. For example, geometry may be culled (i.e., edited) using computer shader tools which run in an asynchronous computing pipeline. For example, this approach may reduce the number of triangles that are encountered by the fixed function triangle processing hardware. In another example, virtualized geometry systems may be used with various procedural culling and level of detail (LoD) techniques to overcome the hard upper limit on number of triangles per unit time. In another example, a synthesis technique which combines advanced culling, geometry LoD and compute-shader based rasterization may increase the number of triangles which may be processed at real-time speeds.

In one example, many synthesis techniques involve high complexity in graphics asset creation. That is, graphics asset creation may require complex, time-consuming offline processing to achieve results that may be consumed in real time.

In one example, 3D scene synthesis may be architected using different approaches. For example, one synthesis approach employs a neural network. For example, the neural network is used to implement a mapping function from input coordinates to output coordinates. For example, the neural network may be constructed iteratively using a learning or training process. In one example, the learning process is based on machine learning (ML).

In one example, a deep neural network (DNN) is used to create graphics assets with rendering techniques at real time speeds to support interactive 3D graphics. One 3D scene synthesis approach is a neural radiance field (NeRF) which uses a trained multilayer perceptron (MLP) to synthesize novel geometric views from arbitrary angles and focal depths. For example, a MLP may be trained using a small number of 2D images (e.g., mobile phone camera images). In one example, creation of NeRF graphics assets may be performed by training a DNN. For example, content creation becomes simplified and ubiquitous since DNN training tools are widely available, unlike other training tools which are complex and expensive. For example, a MLP is a fully connected (i.e., non-convolutional) neural network.

Although content creation might be straightforward using a NeRF, rendering at real-time speeds may be difficult. In one example, NeRF rendering is similar to volumetric ray marching which requires extensive sampling (e.g., hundreds of rays per pixel) and causing MLP inference runs of hundreds of millions times per frame.

In one example, modification of NeRF rendering may employ a latent representation of a radiance field which involves triangle meshes and textures. In one example, the latent representation of an entity has a lower dimensionality (e.g., simpler representation) that the entity itself. That is, the latent representation may use simpler elements (e.g., triangle meshes, textures, etc.) to represent the entity. For example, texture may include per pixel neural features rather than conventional colors or normals. In one example, the latent representation allows more efficient utilization of existing fixed function processor hardware for both triangles and textures with better performance (e.g., throughput) than a volumetric NeRF technique.

In one example, existing fixed function processor hardware for triangle processing has evolved with mesh optimization software tools. For example, the existing hardware was designed for mesh creation without neural rendering techniques. For example, ML training follows different processing conventions than non-neural rendering techniques (e.g., space-filling meshes, large pixel density per triangle, etc.) which may result in performance degradation. In one example, ML techniques generate non-connected triangles (e.g., with no opportunity for post-transform vertex reuse) and use relatively small triangle sizes (e.g., 15 pixels per triangle vs. 50 pixels per triangle for a typical GPU).

In one example, existing triangle rasterization pipeline processing has linear complexity with respect to number of triangles. In one example, each triangle may need to be scan-converted to identify which pixel is covered, and then the covered pixel may need depth testing.

In one example, a ray tracing technique using bounding volume hierarchy (BVH) has logarithmic complexity with respect to number of triangles. For example, logarithmic complexity may be measured in terms of a logarithmic base equal to a BVH tree (e.g., 2, 4, 6 or 8). In one example, BVH is a data structure technique for aggregating entities (e.g., triangles) into bounding boxes in a hierarchical manner. In one example, ray tracing is a synthetic transport model used to simulate light propagation from a source to a destination.

In one example, if the ray tracing technique requires determining a triangle which covers a given screen pixel, a ray tracing algorithm may synthetically emit a ray from a camera to a display screen to find a closest triangle which intersects the ray. For example, usage of BVH in the ray tracing technique permits rejection of a bounding box (e.g., axis-aligned bounding box, AABB) which contains hundreds or thousands of triangles without individual examination of each triangle.

In one example, a modified ray tracing technique which handles triangle meshes generated by ML tools may perform ray tracing to determine primary visibility. In one example, both BVH construction and triangle mesh creation (e.g., via DNN training) may be integrated seamlessly to gain rendering benefits of BVH without additional computational cost. In one example, primary visibility implies existence of a direct optical path from a source (e.g., a viewer) to a destination (e.g., a scene).

In one example, a ray tracing technique to determine primary visibility may be applied to different ML techniques which generate a geometry, such as MobileNeRF, sparse neural radiance grid SNeRG, signed distance field (SDF) generation processes with marching cubes or tetrahedra, etc. In one example, ray tracing for large meshes (e.g., with millions of triangles) may have superior throughput performance compared to other rasterization techniques.

In one example, a ray tracing technique may be decomposed into a plurality of incremental steps. For example, an acceleration structure for all triangles in a frame (e.g., to minimize testing each ray against a large quantity of triangles) may be constructed. For example, ray generation may be performed by an application based on a desired rendering algorithm. For example, a quantity of N rays may be generated per screen pixel, where N may be between ¼ and 4 for real-time applications. For example, determination of an intersection between a ray and a triangle for a given pixel may use an acceleration structure. For example, if an intersection is found, the application may specify a contribution of the ray to a color of the given pixel. For example, additional rays may be generated if a plurality of intersections are found. For example, if there is a low ratio of rays to pixels, denoising may be performed to remove high frequency noise. For example, the application may specify a denoising (i.e., noise removal) algorithm which is matched to a desired rendering algorithm.

In one example, a neural radiance field (NeRF) is a technique for creating new 3D scenes using a plurality of 2D images taken from different viewpoints and generating a 3D volume representation. For example, NeRF may employ a neuron-inspired layered structure for dataset representation. For example, a radiance in physical space is a light energy distribution which traverses a given area in a particular direction over a time interval, in units of watts per square meter per steradian. For example, a field is a continuous energy distribution over a defined volume of space. For example, a radiance in simulation space numerically emulates a radiance in physical space.

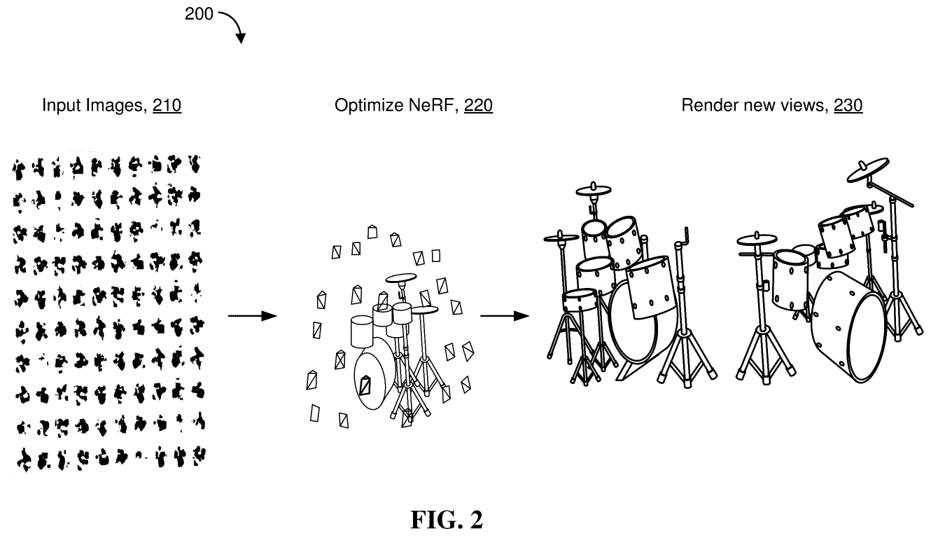

FIG. 2 illustrates an example overview of a NeRF technique 200. In one example, the NeRF technique 200 commences with a plurality of 2D images 210 as an input. In one example, the plurality of 2D images 210 is used to generate a neural network 220 (e.g., optimize NeRF after optimization. In one example, the neural network is used to render new 3D scenes or views 230. using the plurality of 2D images as a basis.

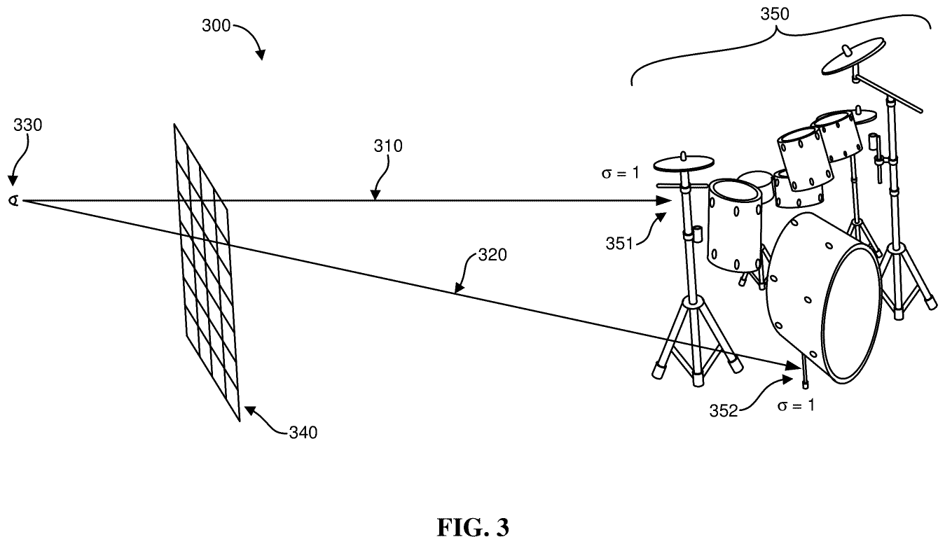

FIG. 3 illustrates a volume density example 300. In one example, a first ray 310 and a second ray 320 are traced from a source 330 through a pixel reference 340 to 3D scene 350. In one example, the first ray 310 terminates at a first endpoint 351 with a first volume density of 1. In one example, the second ray 320 terminates at a second endpoint 352 with a second volume density of 1.

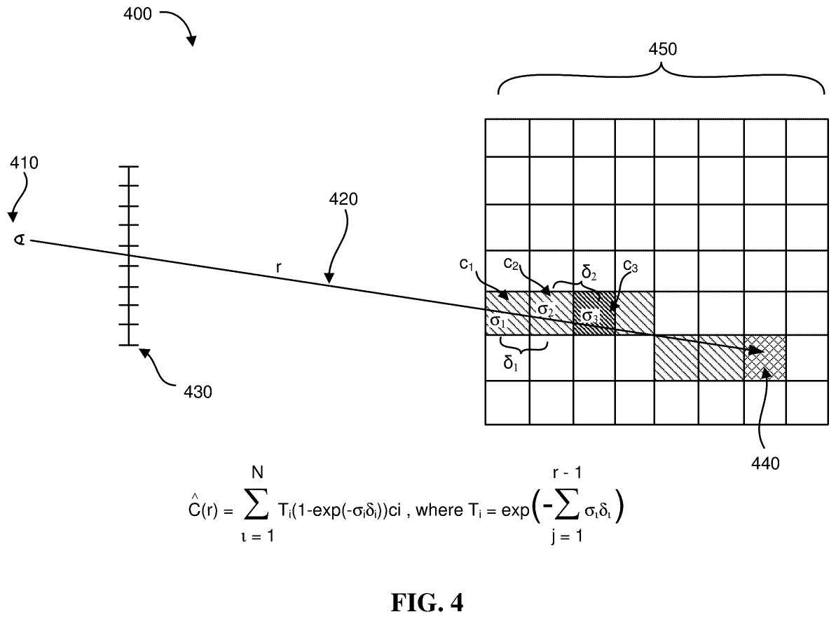

FIG. 4 illustrates a volume rendering example 400. In one example, a source 410 emits a ray 420 through a pixel reference 430 to produce a rendered pixel 440 in a 2D image 450. In one example, the rendered pixel 440 is produced by accumulating a transmittance along the ray 420 (per sample/step) and accumulating a radiance along the ray 420 to obtain pixel color, using the accumulated transmittance.

In one example, the transmittance represents a probability of no particle collision along the ray 420. In one example an estimated color function C(r) at distance r may be expressed as an accumulation over layers of the form.

C(r)=ΣᵢTᵢ[1−exp(σᵢδᵢ)]cᵢ (for i=1 to N)
where,
σᵢ=volume density of layer i
δᵢ=incremental distance for layer i
cᵢ=color of layer i
Tᵢ=incremental transmittance up to layer i=exp[−Σⱼσⱼδⱼ] (for j=1 to i−1)

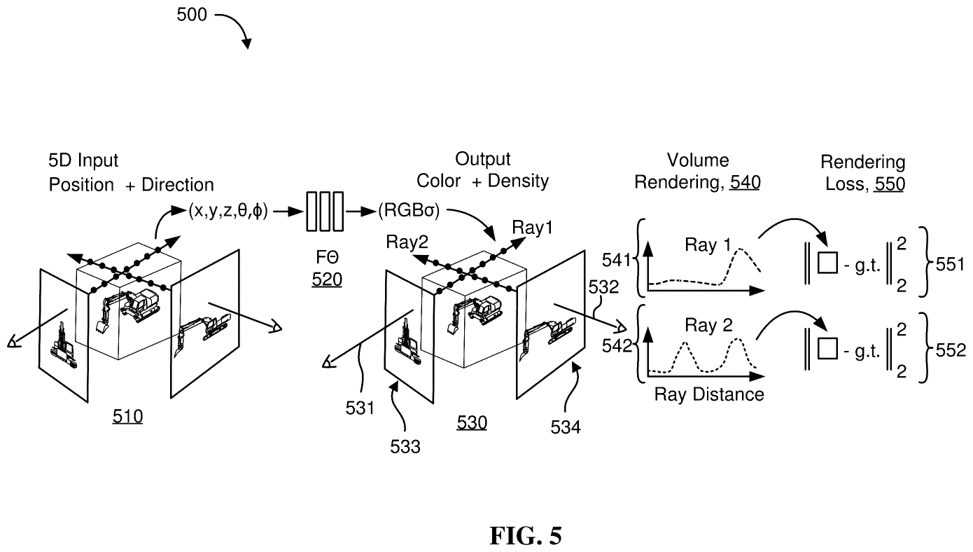

FIG. 5 illustrates a multilayer perceptron (MLP) training example 500. In one example, a plurality of 2D images 510 serves as an input. In one example, the plurality of 2D images is indexed by a five-dimensional input vector. In one example, the five-dimensional input vector includes a 3D spatial position r and a 2D angular orientation k. For example, the 3D spatial position r may be expressed in terms of three Cartesian coordinates (x,y,z). For example, the 2D angular orientation k may be expressed in terms of two angular coordinates (θ,φ).

In one example, a neural network F_{θ} 520 provides a functional mapping between the input scene 510 and an output scene 530. For example, the neural network F_{θ} 520 is a multilayer perceptron (MLP).

In one example, neural network F_{θ} 520 provides the output scene 530 as plurality of colors and a volume density σ. In one example, the plurality of colors is decomposed as red green blue (RGB) components. For example, the output scene 530 includes a first ray 531 associated with a first image 533 and a second ray 532 associated with a second image 534.

In one example, a volume rendering example 540 shows a first volume density profile 541 vs. ray distance for the first ray 531 and a second volume density profile 542 vs. ray distance for the second ray 532. For example, the first volume density profile 541 is used to compute a first estimated color function using the first ray 531 and the second volume density profile 542 is used to compute a second estimated color function using the second ray 532.

In one example, a rendering loss example 550 shows computation of a first rendering loss 551 for the first estimated color function and a second rendering loss 552 for the second estimated color function. For example, the first rendering loss 551 and the second rendering loss 552 are computed as squared differences from a ground truth (g.t.) reference function.

In one example, volume rendering may require intensive computation. For example, if there are 256 neural network (e.g., MLP) queries per ray and 762 000 rays per scene, then the volume rendering computation may require approximately 200 million neural network queries per rendered image. For example, an example GPU throughput results in approximately 30 seconds for each rendered image (i.e., much slower than real time).

In one example, rendering an image using the NeRF technique in an example form may not be efficient on some GPU architectures. In one example, a GPU architecture may be optimized for parallel processing of triangle geometry, rasterization and pixel operations (e.g., texture mapping). For example, the NeRF technique requires sequential ray sampling and accumulation and ray bundling access different sections of a scene volume.

In one example, an image rendering process using NeRF may convert a 3D scene volume representation into a surface geometry representation. In one example, the surface geometry representation is better matched to the GPU architecture.

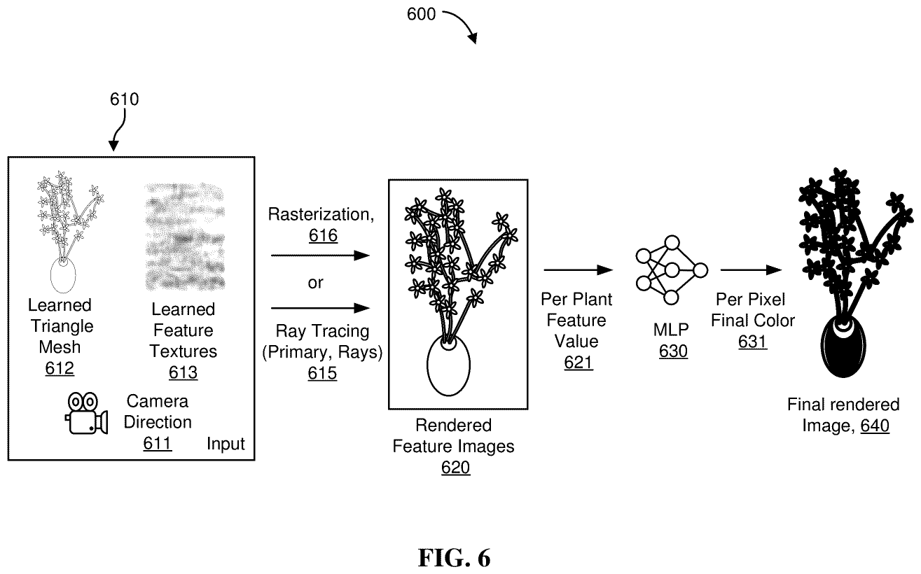

FIG. 6 illustrates an example machine learning (ML) inference algorithmic flow 600. In one example, a plurality of inference inputs 610 includes a camera direction 611, a learned mesh 612 (e.g., a learned triangle mesh) and a learned feature texture 613. For example, the camera direction 611 may be specified by two angular coordinates (θ,φ). For example, the camera direction 611 may be specified by a unit directional vector k with Cartesian coordinates (sin θ cos φ, sin θ sin φ, cos θ). For example, the learned mesh 612 and the learned feature texture 613 are produced by a ML learning algorithm. In one example, the plurality of inference inputs 610 are propagated by ray tracing 615 or rasterization 616 to generate a plurality of rendered feature images 620. In one example, the plurality of rendered feature images 620 along with per pixel feature values 621 are ingested by a neural network 630 (e.g., MLP) to generate a final rendered image 640 along with per pixel final colors 631.

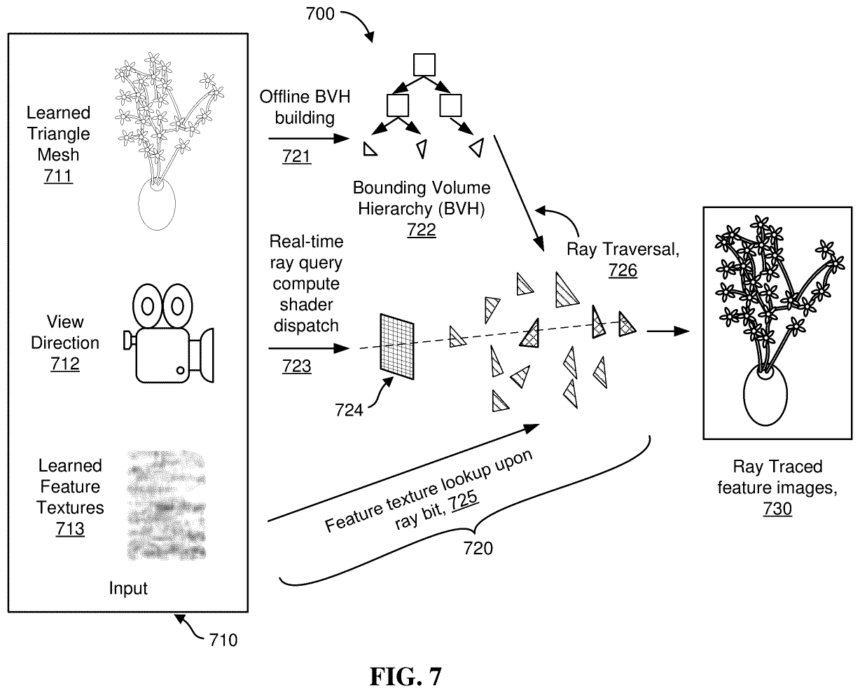

FIG. 7 illustrates an example overview of ray tracing 700. In one example, a plurality of ray tracing inputs 710 includes a learned mesh 711 (e.g., a learned triangle mesh), a view direction 712 and a learned feature texture 713. In one example, the plurality ray tracing inputs 710 are inputs to a ray tracing module 720. In one example, the ray tracing module 720 includes offline BVH building 721, a BVH block 722, real-time ray query compute shader dispatch 723, a shader 724, feature texture lookup block 725 (upon ray hit), and a ray traversal block 726. In one example, a bundle of rays from the ray tracing module 720 are used to generate a plurality of ray traced feature images 730.

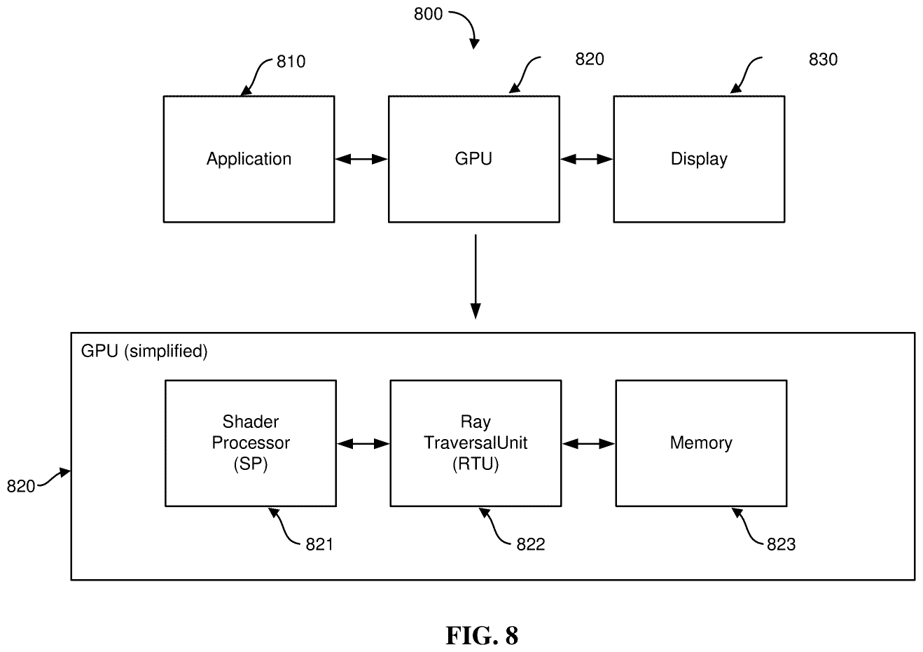

FIG. 8 illustrates an example apparatus 800 for three-dimensional (3D) scene synthesis. In one example, the apparatus 800 includes an application 810, a graphics processing unit (GPU) 820 and a display unit 830. In one example, the GPU 820 includes a shader processor (SP) 821, a ray traversal unit (RTU) 822 and a memory 823.

In one example, a ray query compute shader runs on SP 821 and invokes RTU 822 to execute ray-to-BVH traversal and intersection operations. In one example, intersection determinations are returned to SP 821. In one example, BVH data are stored in memory 823 and fetched as needed by RTU 822.

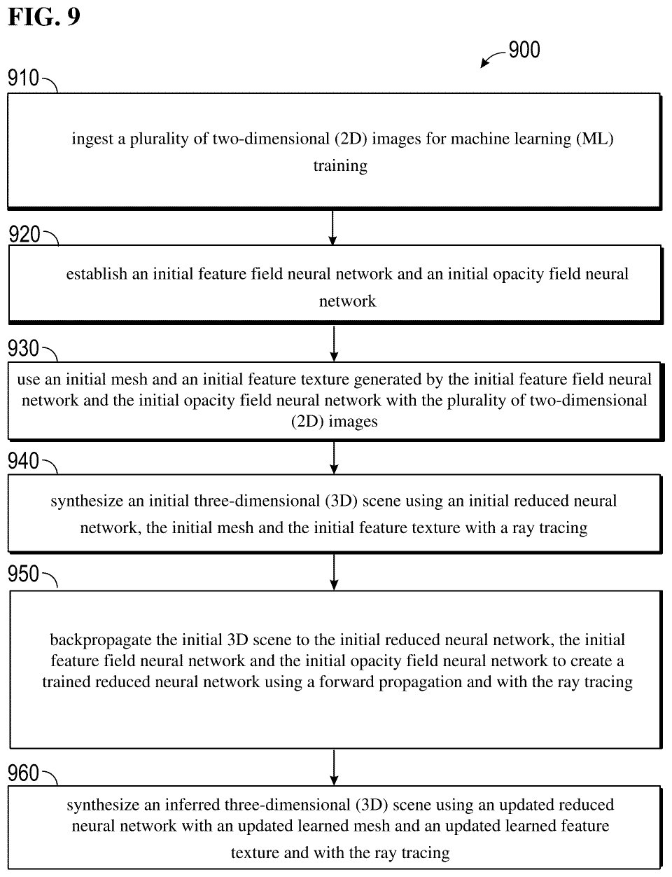

FIG. 9 illustrates an example flow diagram 900 for three-dimensional (3D) scene synthesis using ray tracing and machine learning (ML). In block 910, ingest a plurality of two-dimensional (2D) images for machine learning (ML) training. In one example, a plurality of two-dimensional (2D) images is ingested for machine learning (ML) training. In one example, the plurality of 2D images is indexed by a five-dimensional input vector. In one example, the five-dimensional input vector includes a 3D spatial position r and a 2D angular orientation k. For example, the 3D spatial position r may be expressed in terms of three Cartesian coordinates (x,y,z). For example, the 2D angular orientation k may be expressed in terms of two angular coordinates (θ,φ).

In block 920, establish an initial feature field neural network and an initial opacity field neural network. In one example, an initial feature field neural network and an initial opacity field neural network are established. In one example, the initial feature field neural network is a feature field multilayer perceptron (MLP) neural network. In one example, the initial opacity field neural network is an opacity field multilayer perceptron (MLP) neural network. In one example, the initial feature field neural network specifies a color distribution in 3D space. In one example, the initial opacity field neural network specifies a volume density distribution in 3D space.

In block 930, use an initial mesh and an initial feature texture generated by the initial feature field neural network and the initial opacity field neural network with the plurality of two-dimensional (2D) images. In one example, an initial mesh and an initial feature texture generated by the initial feature field neural network and the initial opacity field neural network with the plurality of two-dimensional (2D) images are used.

In one example, the initial mesh is a set of 3D spatial samples which represents a geometric object. In one example, the initial feature texture is a 2D image of texture features of the geometric object. In one example, the initial mesh is a learnable mesh. In one example, the initial feature texture is a learnable feature texture. In one example, the initial mesh may be updated using an iteration to generate an updated mesh. In one example, the initial feature texture may be updated using an iteration to generate an updated feature texture.

In block 940, synthesize an initial three-dimensional (3D) scene using an initial reduced neural network, the initial mesh and the initial feature texture with a ray tracing. In one example, an initial three-dimensional (3D) scene is synthesized using an initial reduced neural network, the initial mesh and the initial feature texture with a ray tracing. In one example, the ray tracing includes a bounding volume hierarchy (BVH) technique. In one example, the ray tracing includes determination of primary visibility. In one example, the initial reduced neural network has a lower dimensionality than the initial feature field neural network and the initial opacity field neural network.

In block 950, backpropagate the initial 3D scene to the initial reduced neural network, the initial feature field neural network and the initial opacity field neural network to create a trained reduced neural network using a forward propagation and with the ray tracing. In one example, the initial 3D scene is backpropagated to the initial reduced neural network, the initial feature field neural network and the initial opacity field neural network to create a trained reduced neural network using a forward propagation and with the ray tracing. In one example, the ray tracing includes a bounding volume hierarchy (BVH) technique. In one example, the ray tracing includes determination of primary visibility. In one example, the initial 3D scene is synthesized using forward propagation. In one example, forward propagation means processing input data in a direction toward the output.

In block 960, synthesize an inferred three-dimensional (3D) scene using an updated reduced neural network with an updated learned mesh and an updated learned feature texture and with the ray tracing. In one example, an inferred three-dimensional (3D) scene is synthesized using an updated reduced neural network with an updated learned mesh and an updated learned feature texture and with the ray tracing.

In one example, the learned mesh (e.g., learned triangle mesh) may be updated using an iteration to generate the updated learned mesh (e.g., updated learned triangle mesh). In one example, the learned feature texture may be updated using an iteration to generate the updated learned feature texture. In one example, the trained reduced neural network may be updated using an iteration to generate an updated reduced neural network.

In one example, the backpropagation and forward propagation may be performed iteratively. In one example, the iterative backpropagation and forward propagation may be terminated when a stopping rule is reached. In one example, the stopping rule is an a priori condition placed on the initial reduced neural network. In one example, backpropagation means processing output data in a direction toward the input.

In one example, the inferred 3D scene includes view-dependent colors. In one example, the inferred 3D scene is based on neural network optimization. For example, the neural network optimization uses the trained reduced neural network. In one example, the neural network optimization uses forward propagation.

In one aspect, one or more of the steps for providing three-dimensional (3D) scene synthesis using ray tracing and machine learning (ML) in FIG. 9 may be executed by one or more processors which may include hardware, software, firmware, etc. The one or more processors, for example, may be used to execute software or firmware needed to perform the steps in the flow diagram of FIG. 9. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a memory configured to store a learned triangle mesh and a learned feature texture;
a graphics processing unit (GPU) coupled to the memory, the GPU configured to render an inferred three-dimensional (3D) scene based on the learned triangle mesh and the learned feature texture using a ray tracing; and
a display unit coupled to the GPU, the display unit configured to display the inferred 3D scene.

2. The apparatus of claim 1, wherein the GPU comprises a shader processor configured to process the learned triangle mesh and the learned feature texture.

3. The apparatus of claim 2, wherein the GPU further comprises a ray traversal unit configured to perform the ray tracing.

4. The apparatus of claim 3, wherein the ray tracing includes a determination of primary visibility.

5. The apparatus of claim 3, wherein the ray tracing includes a bounding volume hierarchy (BVH) technique.

6. The apparatus of claim 3, wherein the shader processor is further configured to infer the inferred three-dimensional (3D) scene to output view-dependent colors.

7. The apparatus of claim 6, wherein the shader processor is further configured to synthesize the inferred three-dimensional (3D) scene using the reduced neural network with the ray tracing.

8. The apparatus of claim 7, wherein the shader processor is further configured to backpropagate a plurality of two-dimensional (2D) images to the reduced neural network, an initial feature field neural network and an initial opacity field neural network to generate an updated learned triangle mesh and an updated learned feature texture and an updated reduced neural network.

9. The apparatus of claim 8, wherein the shader processor is further configured to infer the updated reduced neural network using a forward propagation and with the ray tracing.

10. The apparatus of claim 9, wherein the shader processor is further configured to synthesize the inferred three-dimensional (3D) scene using the updated reduced neural network with the updated learned triangle mesh and the updated learned feature texture and with the ray tracing.

11. A method comprising:
using an initial mesh and an initial feature texture generated by an initial feature field neural network and an initial opacity field neural network with a plurality of two-dimensional (2D) images; and
synthesizing an initial three-dimensional (3D) scene using an initial reduced neural network, the initial mesh and the initial feature texture with a ray tracing.

12. The method of claim 11, wherein the initial reduced neural network is a multilayer perceptron (MLP) neural network.

13. The method of claim 11, wherein the initial mesh is a set of three-dimensional (3D) spatial samples which represents a geometric object.

14. The method of claim 11, wherein the ray tracing includes a determination of primary visibility.

15. The method of claim 11, wherein the ray tracing includes a bounding volume hierarchy (BVH) technique.

16. The method of claim 11, further comprising using a forward propagation for synthesizing the initial three-dimensional (3D) scene.

17. The method of claim 11, further comprising backpropagating the initial 3D scene to the initial reduced neural network, the initial feature field neural network and the initial opacity field neural network to create a trained reduced neural network using a forward propagation and with the ray tracing.

18. The method of claim 17, further comprising synthesizing an inferred three-dimensional (3D) scene using an updated reduced neural network with an updated learned mesh and an updated learned feature texture and with the ray tracing.

19. The method of claim 18, wherein the ray tracing includes a determination of primary visibility.

20. The method of claim 18, wherein the ray tracing includes a bounding volume hierarchy (BVH) technique.

21. The method of claim 18, further comprising outputting one or more view-dependent 3D scenes from an updated mesh and an updated feature texture.

22. The method of claim 11, wherein the initial reduced neural network has a lower dimensionality than the initial feature field neural network and the initial opacity field neural network.

23. The method of claim 21, further comprising establishing the initial feature field neural network and the initial opacity field neural network.

24. The method of claim 23, further comprising ingesting the plurality of two-dimensional (2D) images for machine learning (ML) training.

25. An apparatus comprising:
means for using an initial mesh and an initial feature texture generated by an initial feature field neural network and an initial opacity field neural network with a plurality of two-dimensional (2D) images; and
mean for synthesizing an initial three-dimensional (3D) scene using an initial reduced neural network, the initial mesh and the initial feature texture with a ray tracing.

26. The apparatus of claim 25, further comprising:
means for backpropagating the initial 3D scene to the initial reduced neural network, the initial feature field neural network and the initial opacity field neural network to create a trained reduced neural network using a forward propagation and with the ray tracing; and
means for synthesizing an inferred three-dimensional (3D) scene using an updated reduced neural network with an updated learned mesh and an updated learned feature texture and with the ray tracing.

27. The apparatus of claim 26, further comprising:
means for establishing the initial feature field neural network and the initial opacity field neural network; and
means for ingesting the plurality of two-dimensional (2D) images for machine learning (ML) training.

28. A non-transitory computer-readable medium storing computer executable code, operable on a device comprising at least one processor and at least one memory coupled to the at least one processor, wherein the at least one processor is configured to implement a three-dimensional (3D) scene synthesis using a ray tracing, the computer executable code comprising:
instructions for causing a computer to use an initial mesh and an initial feature texture generated by an initial feature field neural network and an initial opacity field neural network with a plurality of two-dimensional (2D) images; and
instructions for causing the computer to synthesize an initial three-dimensional (3D) scene using an initial reduced neural network, the initial mesh and the initial feature texture with the ray tracing.

29. The non-transitory computer-readable medium of claim 28, further comprising:
instructions for causing the computer to backpropagate the initial 3D scene to the initial reduced neural network, the initial feature field neural network and the initial opacity field neural network to create a trained reduced neural network using a forward propagation and with the ray tracing; and
instructions for causing the computer to synthesize an inferred three-dimensional (3D) scene using an updated reduced neural network with an updated learned mesh and an updated learned feature texture and with the ray tracing.

30. The non-transitory computer-readable medium of claim 29, further comprising:
instructions for causing the computer to establish the initial feature field neural network and the initial opacity field neural network; and
instructions for causing the computer to ingest the plurality of two-dimensional (2D) images for machine learning (ML) training.
